(19) United States
(12) Patent Application Publication
(10) Pub. No.: US 2016/0037287 A1
(43) Pub. Date: Feb. 4, 2016

(54) METHOD AND APPARATUS FOR PERFORMING A SCANNING OPERATION

(71) Applicant: Samsung Electronics Co., Ltd., Gyeonggi-do (KR)

(72) Inventor: Hee-Jun KIM, Seoul (KR)

(21) Appl. No.: 14/747,188

(22) Filed: Jun. 23, 2015

(30) Foreign Application Priority Data
Jul. 29, 2014 (KR) 10-2014-0096480

(51) Int. Cl. H04W 4/00; H04W 4/02

(52) U.S. Cl. CPC H04W 4/008; H04W 4/02; H04W 88/02

(57) ABSTRACT

A method in an electronic device is provided, including: transmitting, to a server, location-related information associated with the electronic device; receiving, from the server, service-related information associated with at least one short-range communication device, wherein the service-related information is received in response to the location-related information; and performing a scan for the short-range communication device based on the service-related information.

### CLAIM OF PRIORITY

This application claims the benefit under 35 U.S.C. §119(a) of a Korean patent application filed in the Korean Intellectual Property Office on Jul. 29, 2014 and assigned Serial No. 10-2014-0096480, the entire disclosure of which is incorporated herein by reference.

### TECHNICAL FIELD

The present disclosure relates to telecommunications in general, and more particularly to a method and apparatus for performing a scanning operation.

### BACKGROUND

An electronic device may perform short-range communication with its nearby electronic devices. Each electronic device may perform a scanning operation in order to perform the short-range communication. The scanning operation may include an operation of detecting a signal (e.g., a beacon signal) that is transmitted by at least one electronic device. By performing the scanning operation, the electronic device may recognize the presence of at least one its nearby electronic device.

As electronic devices supporting short-range communication have been widespread, an electronic device may detect a variety of its nearby electronic devices. An operation of scanning all of the nearby electronic devices may be inefficient in using a battery of the electronic device.

If the location of an electronic device is fixed, electronic devices which are scanned by the electronic device may be the same in every scanning operation. Accordingly, if the electronic device whose location is fixed performs the scanning operation frequently, the battery consumption may occur due to the unnecessary scanning operation.

The above information is presented as background information only to assist with an understanding of the present disclosure. No determination has been made, and no assertion is made, as to whether any of the above might be applicable as prior art with regard to the present disclosure.

### SUMMARY

According to one aspect of the disclosure, a method in an electronic device is provided, comprising: transmitting, to a server, location-related information associated with the electronic device; receiving, from the server, service-related information associated with at least one short-range communication device, wherein the service-related information is received in response to the location-related information; and performing a scan for the short-range communication device based on the service-related information.

According to another aspect of the disclosure, a method in a server is provided, comprising: receiving, by the server, location-related information associated with an electronic device; identifying service-related information associated with a short-range communication device in response to receiving the location-related information; and transmitting the service-related information to the electronic device.

According to yet another aspect of the disclosure, an electronic device is provided comprising a communication unit and one or more processors configured to: transmit, to a server, location-related information associated with the electronic device; receive, from the server, service-related information associated with at least one short-range communication device; and perform a scan for the short-range communication device based on the service-related information.

According to yet another aspect of the disclosure, a server comprising a communication unit and one or more processors configured to: receive location-related information from an electronic device; and identify service-related information associated with a short-range communication device in response to receiving the location-related information, and control the communication unit to transmit the service-related information to the electronic device.

### BRIEF DESCRIPTION OF THE DRAWINGS

The above and other aspects, features and advantages of certain exemplary embodiments of the present disclosure will be more apparent from the following description taken in conjunction with the accompanying drawings, in which:

FIG. 1 is a diagram illustrating an example of a network environment including an electronic device, according to various embodiments of the present disclosure;

FIG. 2 is a diagram illustrating an example of a service area of an electronic device, according to various embodiments of the present disclosure;

FIG. 3 is a sequence diagram illustrating an example of a process, according to various embodiments of the present disclosure;

FIG. 4 is a flowchart illustrating an example of a process, according to various embodiments of the present disclosure;

FIG. 5 is a flowchart illustrating an example of a process, according to various embodiments of the present disclosure;

FIG. 6 is a timing diagram illustrating an example of a scan cycle of an electronic device, according to various embodiments of the present disclosure;

FIG. 7 is a block diagram illustrating an example of an electronic device, according to various embodiments of the present disclosure;

FIG. 8 is a block diagram illustrating an example of a control module of an electronic device, according to various embodiments of the present disclosure; and

FIG. 9 is a diagram illustrating an example of a server, according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to various embodiments of the present disclosure may be a device with a short-range communication function. For example, the electronic device may include at least one of a smartphone, a tablet (personal computer (PC), a mobile phone, a video phone, an e-book reader, a desktop PC, a laptop PC, a netbook computer, a personal digital assistant (PDA), a portable multimedia player (PMP), an MP3 player, a mobile healthcare device, a digital camera, or a wearable device (e.g., a head-mounted-device (HMD) such as electronic glasses, electronic apparel, electronic bracelet, electronic necklace, appcessory, electronic tattoo, or smart watch).

In some embodiments, the electronic device may be a smart home appliance with a short-range communication function. The smart home appliance, for example, the electronic device may include at least one of a Television (TV), a digital video disk (DVD) player, an audio set, a refrigerator, an air conditioner, a cleaner, an oven, a microwave oven, a washer, an air purifier, a set-top box, a TV box (e.g., a Samsung HomeSync™, an Apple TV™ or a Google TV™), a game console, an electronic dictionary, an electronic key, a camcorder, or an electronic picture frame.

In some embodiments, the electronic device may include at least one of various medical devices (e.g., magnetic resonance angiography (MRA), magnetic resonance imaging (MRI), computed tomography (CT), a medical camcorder, a medical ultrasonic device, etc.), a navigation device, a global positioning system (GPS) receiver, an event data recorder (EDR), a flight data recorder (FDR), an automotive infotainment device, marine electronic equipment (e.g., a marine navigation device, a gyro compass, etc.), an avionics, a security device, a car head unit, an industrial or household robot, an automatic teller's machine for banks, or point of sales (POS) for shops.

In some embodiments, the electronic device may include at least one of a part of furniture or building/structure, an electronic board, an electronic signature receiving device, a projector, or various meters (e.g., water, electricity, gas and radio meters), each of which includes a short-range communication function. The electronic device according to various embodiments of the present disclosure may be any one of the foregoing devices or a combination thereof. In addition, the electronic device according to various embodiments of the present disclosure may be a flexible device. It is apparent to those skilled in the art that the electronic device according to various embodiments of the present disclosure is not limited to the foregoing devices.

The electronic device according to various embodiments of the present disclosure will now be described with reference to the accompanying drawings. The term ‘user’ as used herein may refer to a user who uses the electronic device, or a device (e.g., an intelligent electronic device) that uses the electronic device.

Although an electronic device with a short-range communication module uses a beacon signal as a signal that the electronic device broadcasts to notify the presence thereof according to various embodiments of the present disclosure, the electronic device may use any other signals that are broadcasted to notify the presence of the electronic device in short-range communication.

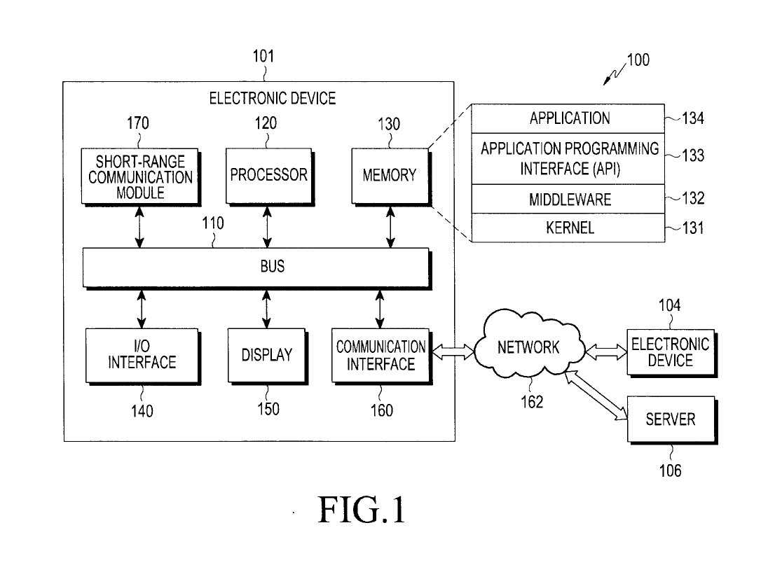

FIG. 1 illustrates an example of a network environment including an electronic device according to various embodiments of the present disclosure. Referring to FIG. 1, an electronic device 101 may include a bus 110, a processor 120, a memory 130, an Input/Output (I/O) interface 140, a display 150, a communication interface 160, and a short-range communication module 170.

The bus 110 may be a circuit for connecting the foregoing components to one another and transferring communication (e.g., a control message) between the foregoing components.

The processor 120 may include one or more of a general-purpose processor (e.g., an ARM-based processor), a Field-Programmable Gate Array (FPGA), an Application Specific Integrated Circuit (FPGA), a Digital Signal Processor (DSP) and/or any other suitable type of processing circuitry. The processor 120 may receive an instruction from the above-described component (e.g., the memory 130, the I/O interface 140, the display 150, the communication interface 160 or the short-range communication module 170) through, for example, the bus 110, decrypt the received instruction, and perform data operations or data processing according to the decrypted instruction.

The memory 130 may store an instruction or data that is received from or generated by the processor 120 or another component (e.g., the I/O interface 140, the display 150, the communication interface 160, or the short-range communication module 170). The memory 130 may include programming modules, such as a kernel 131, middleware 132, an Application Programming Interface (API) 133, an application 134, and/or the like. The above-described programming modules may be respectively configured by software, firmware, hardware or any combination of at least two thereof

The kernel 131 may control or manage system resources (e.g., the bus 110, the processor 120, or the memory 130) used to perform an operation or function implemented by another remaining programming module, for example, the middleware 132, the API 133, the application 134, and/or the like. The kernel 131 may provide an interface for allowing the middleware 132, the API 133, the application 134, and/or the like to access and control or manage respective components of the electronic device 101.

The middleware 132 may perform a relay function such that the API 133 or the application 134 communicates with the kernel 131 for transmission and reception of data. In addition, the middleware 132 may perform control (e.g., scheduling or load balancing) of transaction requests received from a plurality of applications 134 in such a way that a priority of using the system resources (e.g., the bus 110, the processor 120, or the memory 130) of the electronic device 101 is assigned to at least one application among the plurality of applications 134 according to the transaction requests.

The API 133 may be an interface for enabling the applications 134 to control functions provided by the kernel 131 or the middleware 132, and may include, for example, at least one interface or function (e.g., an instruction) for file control, window control, image processing, or character control.

In some embodiments, the applications 134 may include a Short Message Service (SMS)/Multimedia Messaging Service (MMS) application, an Email application, a calendar application, an alarm application, a healthcare application (e.g., an application for measuring the quantity of exercise or the blood glucose), an environmental information application (e.g., an application for providing information about the pressure, humidity or temperature), and/or the like. Additionally or alternatively, the applications 134 may be applications related to information exchange between the electronic device 101 and an external electronic device (e.g., an electronic device 104). The applications related to information exchange may include, for example, a notification relay application for relaying specific information to the external electronic device, or a device management application for managing the external electronic device.

For example, the notification relay application may include a function of relaying notification information generated by another application (e.g., the SMS/MMS application, an Email application, a healthcare application, an environmental information application and/or the like) of the electronic device 101, to the external electronic device (e.g., the electronic device 104). Additionally or alternatively, the notification relay application may receive notification information from, for example, the external electronic device (e.g., the electronic device 104) and provide the notification information to the user. The device management application may manage a function (e.g., a function of turning on/off the external electronic device itself (or some components thereof) or adjusting the brightness (or resolution) or the display) for at least a part of, for example, the external electronic device (e.g., the electronic device 104) that communicates with the electronic device 101, and may manage (e.g., install, delete or update) an application that runs in the external electronic device, or a service (e.g., a call service or a message service) that is provided in the external electronic device.

In some embodiments, the applications 134 may include applications that are specified depending on the external electronic device (e.g., depending on the properties (e.g., the type of the electronic device) of the electronic device 104). For example, if the external electronic device is an MP3 player, the applications 134 may include an application related to playback of music. Similarly, if the external electronic device is a mobile healthcare device, the applications 134 may include an application related to healthcare. In one embodiment, the applications 134 may include at least one of an application stored in the electronic device 101 and an application received from the external electronic device (e.g., a server 106 or the electronic device 104).

In some embodiments, the I/O interface 140 may receive an instruction or data from a user through an I/O device (e.g., a sensor, a keyboard or a touch screen) and transfer the instruction or data to the processor 120, the memory 130, the communication interface 160 or the short-range communication module 170 through, for example, the bus 110. For example, the I/O interface 140 may provide the data for a user's touch made on the touch screen to the processor 120. In addition, the I/O interface 140 may receive an instruction or data from the processor 120, the memory 130, the communication interface 160 or the short-range communication module 170 through, for example, the bus 110, and output the received instruction or data through the I/O device (e.g., a speaker or a display). For example, the I/O interface 140 may output the voice data that is processed by the processor 120, to the user through the speaker.

The display 150 may display various types of information (e.g., multimedia data, text data and/or the like), for the user.

The communication interface 160 may connect communication between the electronic device 101 and the external electronic device (e.g., the electronic device 104 or the server 106). For example, the communication interface 160 may be connected to a network 162 through wireless communication or wired communication to communicate with the external electronic device. The wireless communication may include at least one of, for example, wireless fidelity (WiFi), Bluetooth (BT), Bluetooth low energy (BLE), near field communication (NFC), global positioning system (GPS), or cellular communication (e.g., long-term evolution (LTE), long-term evolution-advanced (LTE-A), code division multiple access (CDMA), wideband code division multiple access (WCDMA), universal mobile telecommunication system (UMTS), wireless broadband (WiBro), global system for mobile communication (GSM), and/or the like). The wired communication may include at least one of, for example, universal serial bus (USB), high-definition multimedia interface (HDMI), recommended standard 232 (RS-232), or plain old telephone service (POTS).

In one embodiment, the network 162 may be a telecommunications network. The telecommunications network may include at least one of a computer network, the Internet, Internet of things (IoT), or a telephone network. In one embodiment, a protocol (e.g., a transport layer protocol, a data link layer protocol or a physical layer protocol) for communication between the electronic device 101 and the external electronic device may be supported in at least one of the application 134, the API 133, the middleware 132, the kernel 131 or the communication interface 160.

According to various embodiments of the present disclosure, the short-range communication module 170 may transmit to the server 106 location-related information. The location-related information may identify the current location of the electronic device, and/or an area information of the electronic device 101. For example, the location information may include any information capable of indicating the location of the electronic device, such as GPS information, satellite information, Wi-Fi Protected Setup (WPS) information, location information based on the triangulation method, information indicating the structure of the surrounding buildings using a magnetic field, and latitude and longitude information.

For example, the area information may be information about the area within a specific radius around the location of the electronic device 101.

The short-range communication module 170 may receive, from the server 106, information (e.g., service related information) associated with a short-range communication device (e.g., a beacon transmission device) that is available in the area that is set based on the location information. The information related to a short-range communication device (e.g., service-related information) may include a list of nearby devices (e.g., short-range communication devices), and may also include an encryption key, a password and identification (ID) information corresponding to each of the nearby devices.

For example, the short-range communication module 170 may determine whether at least one electronic device discoverable by the electronic device 101 is present in the vicinity of the electronic device 101, in an initial operation after power is supplied (e.g., when the short-range communication module 170 is enabled). The processor 120 may control a scanning operation (e.g., determine whether to perform a scanning operation) depending on whether the device-related information received from the server 106 includes at least one discoverable short-range communication device.

For example, the processor 120 may control the short-range communication module 170 to perform a scanning operation for the short-range communication device based on the information related to the short-range communication device (e.g., service-related information received from the server 106). For example, the short-range communication module 170 may detect a beacon signal transmitted from at least one short-range communication device.

Furthermore, the processor 120 may control the short-range communication module 170 to request at least one service corresponding to the at least one short-range communication device.

According to various embodiments of the present disclosure, the server 106 may determine a location of the electronic device 101, according to receive the request including location-related information associated with the at least one short-range communication device. For example, the server 106 may search information related the determined location among stored service-related information and transmit data (e.g., the searched information) to the electronic device 101.

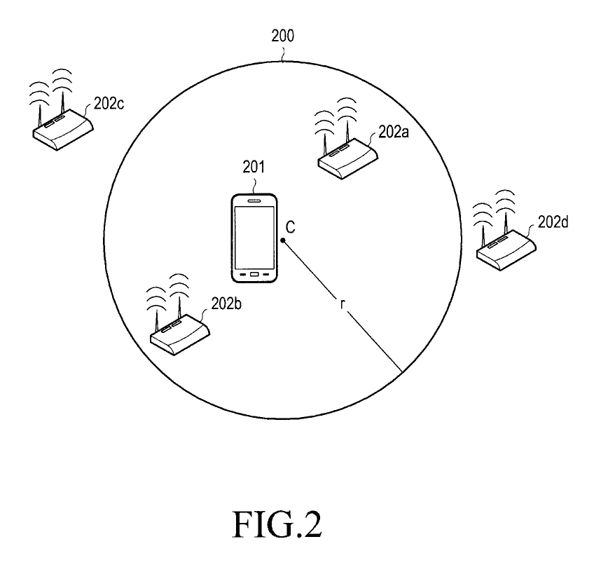

FIG. 2 is a diagram illustrating an example of a service area of an electronic device, according to various embodiments of the present disclosure. Referring to FIG. 2, an example of a network is shown that includes an electronic device 201 and at least one short-range communication device 202a, 200b, 200c or 200d (e.g., a beacon transmission device).

According to various embodiments of the present disclosure, the electronic device 201 may transmit its location information or area information to a server (e.g., the server 106). For example, the area information may include information about the area where the electronic device 201 desires to receive a service. The area may be defined based on the current location C of the electronic device 201. For example, the area information may include values of the current location C and the radius r.

According to various embodiments of the present disclosure, the server may set a service area 200 using the location information or area information (e.g., C and r) of the electronic device 201. The server may transmit, to the electronic device 201, information related to a short-range communication device(s) that are potentially discoverable in the service area 200 (e.g., service-related information). For example, the information related to a short-range communication device may include information associated with the first short-range communication device 202a and the second short-range communication device 202b.

According to various embodiments of the present disclosure, the electronic device 201 may perform a scanning operation upon receiving the information related to a discoverable short-range communication device (e.g., a device located in the service area 200). For example, the scanning operation may be an operation of scanning a beacon signal that is broadcasted from a device with a BT or BLE module. According to various embodiments of the present disclosure, the electronic device 201 may request, from the server, a service (e.g., a content delivery service) for a discovered short-range communication device that is located in the area 200 (e.g., the first short-range communication device 202a or the second short-range communication device 202b).

According to various embodiments of the present disclosure, the server may receive the request including location-related information associated with the at least one short-range communication device. The location-related information might be included in the request, according that the electronic device 201 discovers the at least one short-range communication device by scanning the beacon signal.

For example, the server may search information corresponding to the location-related information among stored service-related information and transmit data (e.g., the searched information) to the electronic device 201.

For example, if only the third short-range communication device 202c or the fourth short-range communication device 202d, which is presently included in the network, is discovered as by the server, the server may determine that there is no discoverable device in the service area 200. In this case, according to various embodiments of the present disclosure, the electronic device 201 may not perform the scanning operation.

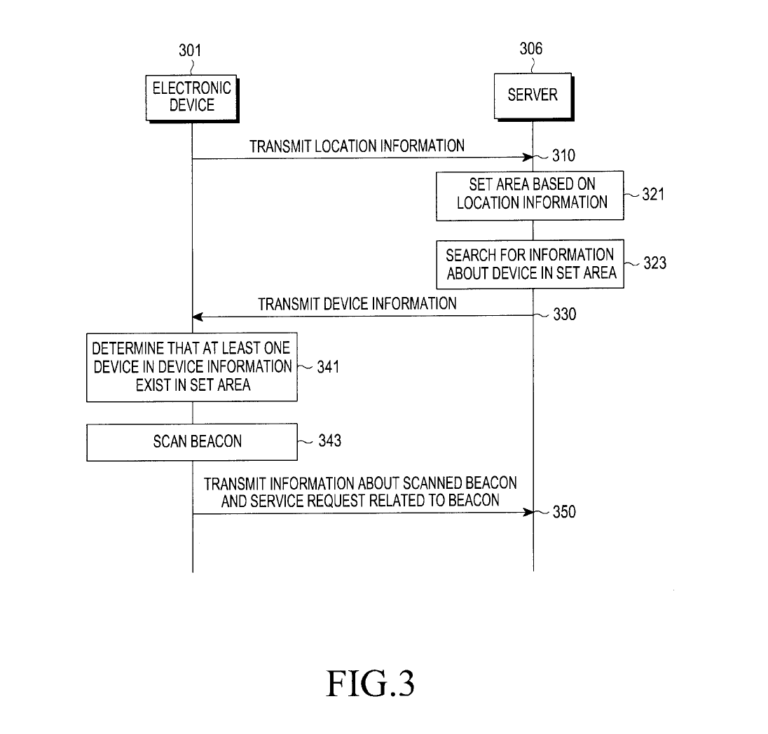

FIG. 3 is a sequence diagram illustrating an example of a process, according to various embodiments of the present disclosure. Referring to FIG. 3, in operation 310, an electronic device 301 may transmit its location information (e.g., GPS or coordinate information, etc.).

In operation 321, a server 306 may set a service area based on the location information.

In operation 323, the server 306 may search for information related to a short-range communication device in the set area. For example, the information related to a short-range communication device may include at least one of information items released to short-range communication devices which can be discovered by the electronic device 301 in the area.

In operation 330, the server 306 may transmit device information (e.g., service related information) associated with a short-range communication device to the electronic device 301.

In operation 341, the electronic device 301 may determine from the device information that the short-range communication device is present in the set area. The electronic device 301 may determine whether to perform a scanning operation, depending on whether the short-range communication device is present in the set area.

In operation 343, the electronic device 301 may scan for a beacon signal of the short-range communication device, if at least one device in the device information is present in the set area.

In operation 350, the electronic device 301 may transmit information obtained from the scanned beacon signal and a service request related to the beacon to the server 306.

According to various embodiments of the present disclosure, the obtained information may include information related to location of the at least one short-range communication device. For example, the server 306 may determine location information of the electronic device 301 based on the information related to location included in the obtained information.

According to various embodiments of the present disclosure, the beacon signal that is scanned by the electronic device 301 may be a beacon signal that is broadcasted by electronic devices (e.g., short-range communication devices) identified in the device information. For example, the electronic device 301 may scan only the beacon signals broadcasted by the short-range communication devices corresponding to the device information, which is received from the server 306, and may receive a service corresponding to the beacon signals.

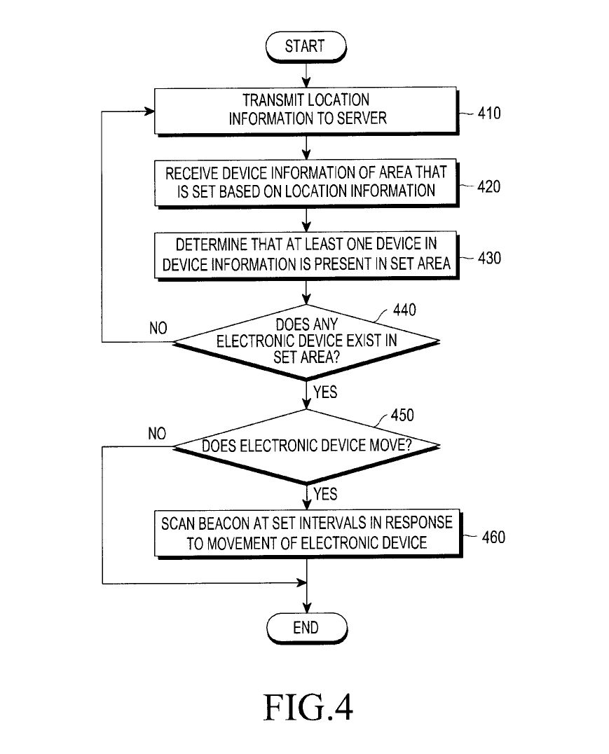

FIG. 4 is a flowchart illustrating an example of a process, according to various embodiments of the present disclosure. Referring to FIG. 4, in operation 410, the electronic device may transmit its location information (e.g., location-related information) to a server.

In operation 420, the electronic device may receive device information (e.g., service-related information) of the area that is set based on the location information.

In operation 430, the electronic device may determine whether at least one device identified in the device information is present in the set area.

If it is determined in operation 440 that the electronic device is present in the set area, the electronic device may determine in operation 450 whether the electronic device is moving.

If it is determined that the electronic device is moving, the electronic device may perform a beacon scanning operation at set intervals in response to the movement of the electronic device, in operation 460.

However, if it is determined that the electronic device is not moving, the electronic device may refrain from performing the beacon scanning operation.

If it is determined in operation 440 that the electronic device is not present in the set area, the electronic device may transmit updated location-related information to the server in operation 410.

For example, the operation method in the electronic device according to various embodiments of the present disclosure may include transmitting location-related information of the electronic device to a server; receiving, from the server, information related to at least one short-range communication device, which is set in response to the location-related information; and determining whether to perform scanning, based on the received information related to at least one short-range communication device.

The determining whether to perform scanning may include determining an area that is set in response to the location-related information; and performing scanning if it is determined that at least one short-range communication device in the received information related to at least one short-range communication device is present in the set area. The location-related information may include information about an area where the electronic device desires to receive a service.

The short-range communication device may be a beacon transmission device.

The operation method in the electronic device may further include detecting movement of the electronic device; and setting a scan cycle in a time interval where the movement is detected. The movement of the electronic device may be detected using a signal received from at least one of a pedometer, an accelerometer, a gravimeter and a speedometer.

The operation method in the electronic device may further include determining whether the electronic device is out of the set area; and transmitting changed location information of the electronic device to the server, if the electronic device is out of the set area.

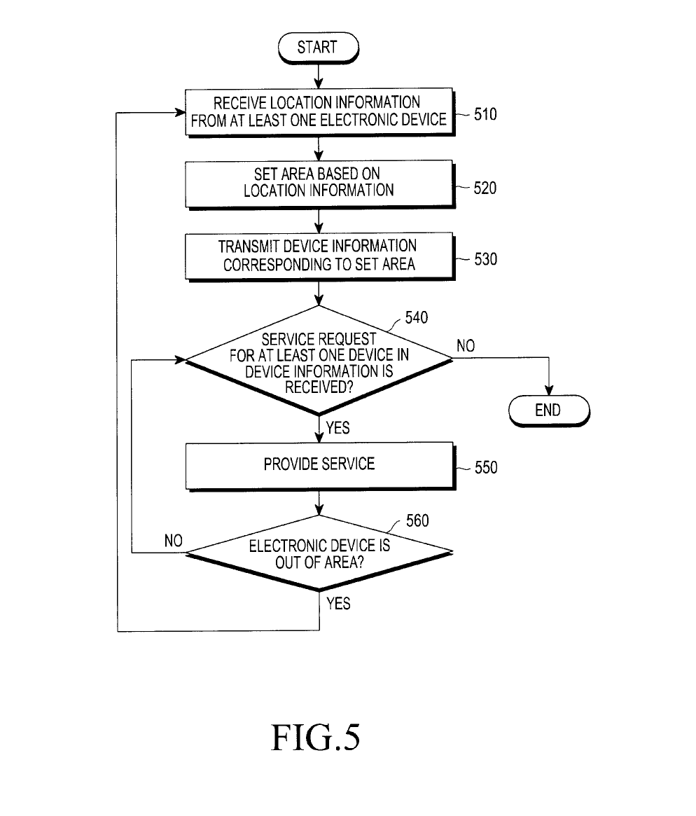

FIG. 5 is a flowchart illustrating an example of a process, according to various embodiments of the present disclosure. Referring to FIG. 5, in operation 510, the server may receive location-related information from at least one electronic device. The location-related information may include information indicating the current location of the electronic device, or an indication of a preferred area (e.g., a radius value which defines a region around the current location of the electronic device in which the electronic device desires to receive a service).

In operation 520, the server may set a service area based on the location-related information.

In operation 530, the server may transmit device information for the set area. According to various embodiments of the present disclosure, the server may identify information related to a short-range communication device that is in or near the set area. The server may transmit the found information to the electronic device.

In operation 540, the server may determine whether a service request is received from at least one device in the device information. Upon receiving the service request, the server may provide a service (e.g., a data transmission service) corresponding to the request, to the electronic device in operation 550.

In operation 560, the server may determine whether the electronic device has exited the service area. According to various embodiments of the present disclosure, upon receiving updated location-related information from the electronic device, the server may determine that the electronic device is out of the service area.

If it is determined that the electronic device is out of the service area, the server may receive again location information from at least one electronic device in operation 510. The server may set a new service area based on the received location-related information.

If it is determined that the electronic device is still located in the service area, the server may receive again a service request for at least one device in the device information in operation 540.

For example, the operation method in the server according to various embodiments of the present disclosure may include receiving location-related information from at least one electronic device; searching for information related to a short-range communication device, which is set in response to the location-related information; and transmitting the identified information to the at least one electronic device.

The operation method in the server may further include determining that the at least one electronic device is out of an area that is set in response to the location-related information, if the server re-receives location-related information from the at least one electronic device.

The operation method in the server may further include providing a service corresponding to the location-related information to at least one electronic device, if information about the at least one electronic device is found in advance in response to the location-related information.

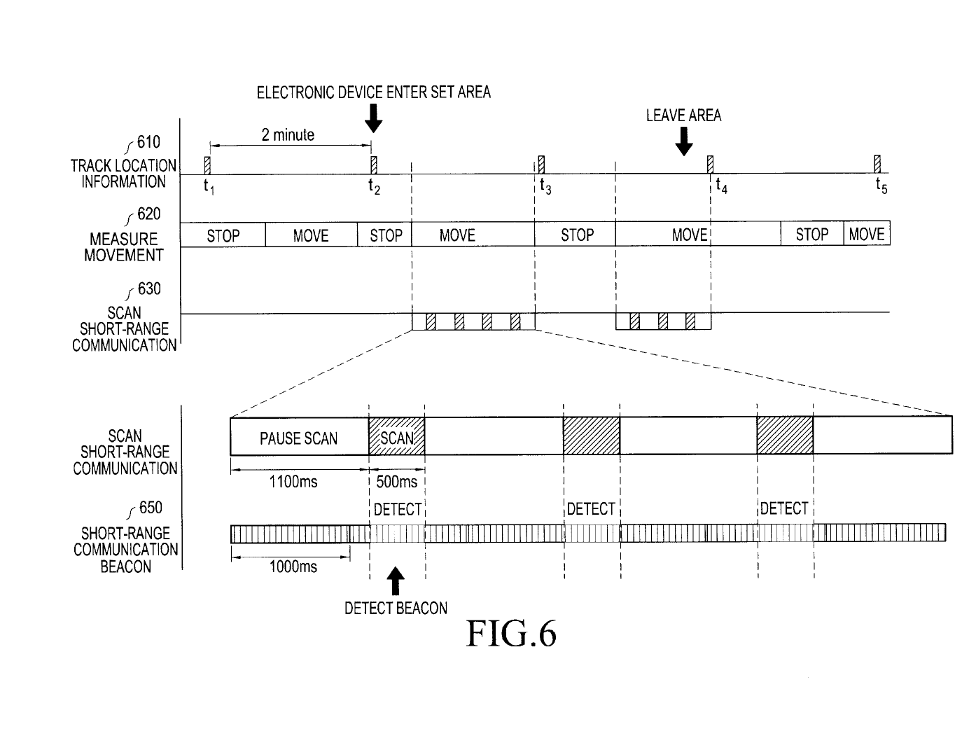

FIG. 6 is a timing diagram illustrating an example of a scan cycle of an electronic device according to various embodiments of the present disclosure. Referring to FIG. 6, timing 610 for location information tracking may be repeated at a specific time (e.g., t₁, t₂, t₃, t₄, or t₅) at regular intervals (e.g., 2 minutes). The electronic device may track its location at each specific time.

For example, an electronic device will be assumed to exist in a set area at a time t₂. If the electronic device transmits its current location information to the server and determines that a service area is set in response to the location information, it can be determined that the electronic device is located in the set area.

The electronic device may be out of the set area, as it moves. For example, at a time t₄, it can be determined that the electronic device is out of the set area.

According to various embodiments of the present disclosure, the electronic device may measure its movement as shown by reference numeral 620. For example, the electronic device may include a variety of sensor modules, and measure its movement using signals received through the variety of sensor modules. For example, the electronic device may determine whether the electronic device has moved, using a pedometer, an accelerometer, a gravimeter, a speedometer and/or the like.

Referring to FIG. 6, a movement state of the electronic device may be determined depending on the movement measurement 620. The movement state may include a stopped state or a moving state. Upon detecting that the electronic device is moving, the electronic device may determine that the electronic device is in the moving state. If it is determined that the electronic device is in the moving state, the electronic device may perform the scanning operation.

According to various embodiments, as shown in FIG. 6 by timing 630 for scanning short-range communication, the electronic device may repeatedly perform an operation of pausing the scanning for 1100 ms and then performing the scanning for 500 ms.

According to various embodiments of the present disclosure, the electronic device may perform the periodic scanning operation 630 between the time it is determined that the electronic device has entered the set area and the time it is determined that the electronic device is out of the set area (e.g., between t₂ and t₄).

For example, the signal that is scanned for by the electronic device may be a beacon signal that is broadcasted from a short-range communication device. For example, the electronic device may scan a beacon signal as shown by reference numeral 630 in a time interval corresponding to the state where the electronic device moves, out of the time interval where the electronic device performs the scanning operation.

A short-range communication device with a short-range communication module may broadcast a beacon signal 650 for short-range communication at predetermined intervals (e.g., 1000 ms).

According to various embodiments of the present disclosure, upon detecting a beacon signal that is broadcasted in the time interval where the electronic device performs scanning, the electronic device may transmit the detected beacon signal information to the server. The server may provide a service related to the detected beacon signal information to the electronic device.

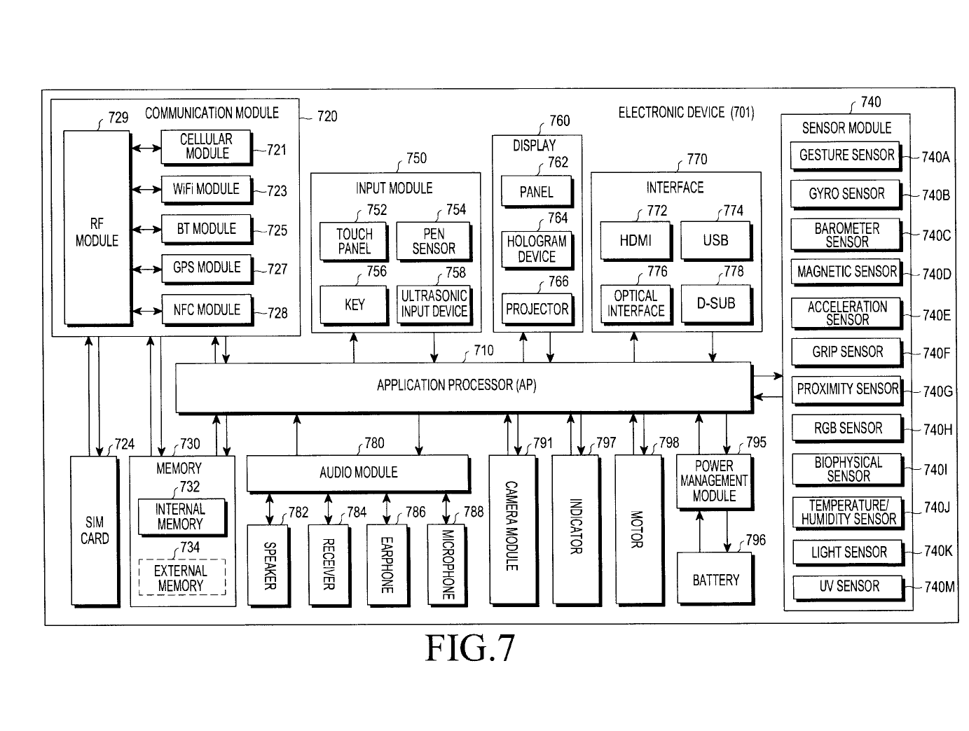

FIG. 7 is a block diagram illustrating an example of a configuration of an electronic device according to various embodiments of the present disclosure. An electronic device 701 may constitute, for example, the whole or part of the electronic device 101 shown in FIG. 1. Referring to FIG. 1, the electronic device 701 may include one processor (e.g., an application processor (AP) 710, a communication module 720, a subscriber identification module (SIM) card 724, a memory 730, a sensor module 740, an input device 750, a display 760, an interface 770, an audio module 780, a camera module 791, a power management module 795, a battery 796, an indicator 797, and a motor 798.

The AP 710 may execute an operating system or application programs to control a plurality of hardware or software components connected to the AP 710, and may perform data processing and data operations on various kinds of data including multimedia data. The AP 710 may be implemented by, for example, a System on Chip (SoC). According to an embodiment of the present disclosure, the AP 710 may further include a Graphic Processing Unit (GPU) (not shown).

The communication module 720 (e.g., the communication interface 160) may perform data transmission/reception in communication between the electronic device 701 (e.g., the electronic device 101) and other electronic devices (e.g., the electronic device 104 or the server 106) that are connected thereto over the network. According to one embodiment, the communication module 720 may include a cellular module 721, a WiFi module 723, a BT module 725, a GPS module 727, an NFC module 728, and a radio frequency (RF) module 729.

The cellular module 721 may provide a voice call, a video call, a text service, an Internet service and/or the like over the communication network (e.g., LTE, LTE-A, CDMA, WCDMA, UMTS, WiBro, GSM and/or the like). In addition, the cellular module 721 may perform identification and authentication for an electronic device in the communication network using, for example, a subscriber identification module (e.g., the SIM card 724). According to one embodiment, the cellular module 721 may perform at least some of the functions that can be provided by the AP 710. For example, the cellular module 721 may perform at least some of the multimedia control functions.

According to one embodiment, the cellular module 721 may include a communication processor (CP). The cellular module 721 may be implemented by, for example, SoC. Although the components such as the cellular module 721 (e.g., the communication processor), the memory 730, the power management module 795 and/or the like are illustrated as separate components from the AP 710 in FIG. 7, the AP 710 may be implemented to include at least some (e.g., the cellular module 721) of the above-described components according to one embodiment.

According to one embodiment, the AP 710 or the cellular module 721 (e.g., the communication processor) may load an instruction or data received from at least one of a non-volatile memory or other components connected to thereto, on a volatile memory, and process the loaded instruction or data. In addition, the AP 710 or the cellular module 721 may store, in a non-volatile memory, the data that is received from or generated by at least one of the other components.

The WiFi module 723, the BT module 725, the GPS module 727 or the NFC module 728 each may include, for example, a processor for processing the data that is transmitted or received through the module. Although the cellular module 721, the WiFi module 723, the BT module 725, the GPS module 727 or the NFC module 728 each is illustrated as a separate block in FIG. 7, at least some (e.g., two or more) of the cellular module 721, the WiFi module 723, the BT module 725, the GPS module 727 or the NFC module 728 may be incorporated into one integrated chip (IC) or IC package according to one embodiment. For example, at least some (e.g., a communication processor corresponding to the cellular module 721 and a WiFi processor corresponding to the WiFi module 723) of the processors corresponding to the cellular module 721, the WiFi module 723, the BT module 725, the GPS module 727 or the NFC module 728 may be implemented by one SoC.

The RF module 729 may perform transmission and reception of data, for example, transmission and reception of RF signals. Although not shown, the RF module 729 may include, for example, a transceiver, a Power Amp Module (PAM), a frequency filter, a Low Noise Amplifier (LNA), and/or the like. The RF module 729 may further include a component (e.g., a conductor or a conductive line) for transmitting and receiving electromagnetic waves in free space for wireless communication. Although the cellular module 721, the WiFi module 723, the BT module 725, the GPS module 727 and the NFC module 728 are illustrated to share one RF module 729 with one another in FIG. 7, at least one of the cellular module 721, the WiFi module 723, the BT module 725, the GPS module 727 or the NFC module 728 may perform transmission and reception of RF signals through a separate RF module according to one embodiment.

The SIM card 724 may be a card with a subscriber identification module, and may be inserted into a slot that is formed in a specific position of the electronic device. The SIM card 724 may include unique identification information (e.g., integrated circuit card identifier (ICCID)) or subscriber information (e.g., international mobile subscriber identity (IMSI)).

The memory 730 (e.g., the memory 130) may include an internal memory 732 or an external memory 734. The internal memory 732 may include at least one of, for example, a volatile memory (e.g., Dynamic Random-Access Memory (DRAM), Static Random-Access Memory (SRAM), Synchronous Dynamic Random-Access Memory (SDRAM), and/or the like) or a nonvolatile memory (e.g., One-Time Programmable Read Only Memory (OTPROM), Programmable Read Only Memory (PROM), Erasable Programmable Read Only Memory (EPROM), Electrically Erasable Programmable Read Only Memory (EEPROM), mask ROM, flash ROM, NAND flash memory, NOR flash memory, and/or the like).

According to one embodiment, the internal memory 732 may be a Solid State Drive (SSD). The external memory 734 may further include a flash drive, for example, a Compact Flash (CF) card, a Secure Digital (SD) card, a Micro Secure Digital (Micro-SD) card, a Mini Secure Digital (Mini-SD) card, an extreme Digital (xD) card, a memory stick, and/or the like. The external memory 734 may be functionally connected with the electronic device 701 through a variety of interfaces. According to one embodiment, the electronic device 701 may further include a storage device (or a storage medium) such as a hard drive.

The sensor module 740 may measure the physical quantity or detect the operating status of the electronic device 701, and convert the measured or detected information into an electrical signal. The sensor module 740 may include at least one of, for example, a gesture sensor 740A, a gyro sensor 740B, a barometer 740C, a magnetic sensor 740D, an acceleration sensor 740E, a grip sensor 740F, a proximity sensor 740G, a color sensor (e.g., a Red-Green-Blue (RGB) sensor) 740H, a biophysical sensor 740I, a temperature/humidity sensor 740J, a light sensor 740K, an Ultra Violet (UV) sensor 740M, and/or the like. Additionally or alternatively, the sensor module 740 may include, for example, an E-nose sensor (not shown), an ElectroMyoGraphy (EMG) sensor (not shown), an ElectroEncephaloGram (EEG) sensor (not shown), an ElectroCardioGram (ECG) sensor (not shown), an infra red (IR) sensor (not shown), an iris sensor (not shown), a fingerprint sensor (not shown), and/or the like. The sensor module 740 may further include a control circuit for controlling at least one sensor included therein.

The input device 750 may include a touch panel 752, a (digital) pen sensor 754, a key 756, or an ultrasonic input device 758. The touch panel 752 may recognize a touch input using at least one method of, for example, a capacitive method, a pressure-sensitive method, an IR method, an ultrasonic method, and/or the like. In addition, the touch panel 752 may further include a control circuit (not shown). In the case of the capacitive method, the touch panel 752 may recognize the physical contact or the proximity. The touch panel 752 may further include a tactile layer. In this case, the touch panel 752 may provide a tactile response to a user.

The (digital) pen sensor 754 may be implemented by using, for example, a method identical or similar to a method for receiving a user's touch input or a separate recognition sheet. The key 756 may include, for example, a physical button, an optical key, a keypad, and/or the like. The ultrasonic input device 758 may be a device for detecting a sound wave using a microphone (e.g., the microphone 788) and identifying data in the electronic device 701, through an input tool for generating an ultrasonic signal to facilitate wireless recognition. According to one embodiment, the electronic device 701 may receive a user input from an external device (e.g., a computer, a server, and/or the like) connected thereto by using the communication module 720.

The display 760 (e.g., the display 150) may include a panel 762, a hologram 764 or a projector 766. The panel 762 may be, for example, a Liquid Crystal Display (LCD) panel, an Active Matrix Organic Light-Emitting Diode (AM-OLED) panel, and/or the like. The panel 762 may be implemented to be, for example, flexible, transparent, or wearable. The panel 762 may be formed as one module with the touch panel 752. The hologram 764 may enable a 3D image to be viewed in space using optical interference. The projector 766 may display images by projecting the light on the screen. The screen may be mounted on, for example, the inside or outside of the electronic device 701. According to one embodiment, the display 760 may further include a control circuit for controlling the panel 762, the hologram 764 or the projector 766.

The interface 770 may include, for example, an HDMI 772, a USB 774, an optical interface 776, or a D-subminiature (D-sub) 778. The interface 770 may be incorporated into, for example, the communication interface 160 shown in FIG. 1. Additionally or alternatively, the interface 770 may include, for example, a mobile high-definition link (MHL) interface, a Secure Digital (SD)/Multi-Media Card (MMC) interface (not shown), an Infrared Data Association (IrDA) interface (not shown), and/or the like.

The audio module 780 may perform bidirectional conversion between voice and electrical signals. At least some components of the audio module may be incorporated into, for example, the I/O interface 140 shown in FIG. 1. The audio module 780 may perform conversion of voice information input or output through, for example, a speaker 782, a receiver 784, an earphone 786, a microphone 788, and/or the like.

The camera module 791 may be a device for capturing a still image and moving images. According to one embodiment, the camera module 791 may include at least one image sensor (e.g., a front sensor or a rear sensor), a lens (not shown), an image signal processor (ISP) (not shown), or a flash (e.g., LED or xenon lamp) (not shown).

The power management module 795 may manage power of the electronic device 701. Although not shown, the power management module 795 may include, for example, a Power Management IC (PMIC), a charger IC, a battery or fuel gauge, and/or the like.

The PMIC may be mounted within, for example, an integrated circuit or a SoC semiconductor. A charging method may include a wired charging method and a wireless charging method. The charger IC may charge a battery and prevent the application of overvoltage or over-current from a charger. According to one embodiment, the charger IC may include a charger IC employing at least one of a wired charging method or a wireless charging method. The wireless charging method may include, for example, a magnetic resonance method, a magnetic induction method, or an electromagnetic wave method. An additional circuit for wireless charging may include, for example, circuits such as a coil loop, a resonance circuit, or a rectifier.

The battery gauge may measure, for example, a remaining amount of power, or a voltage, a current or a temperature during charging with respect to the battery 796. The battery 796 may store or generate electricity, and supply power to the electronic device 701 using the stored or generated electricity. The battery 796 may include, for example, a rechargeable battery or a solar battery.

The indicator 797 may represent a specific state of the electronic device 701 or a component thereof (e.g., the AP 710), for example, a booting state, a message state, a charge state, and/or the like. The motor 798 may convert an electrical signal into mechanical vibration. Although not shown, the electronic device 701 may include a processing device (e.g., a Graphical Processing Unit (GPU)) for supporting a mobile TV. The processing device for supporting a mobile TV may process media data based on, for example, Digital Media Broadcast (DMB), Digital Video Broadcasting (DVB) or Media Flow™.

The names of the above-described components of the electronic device according to various embodiments of the present disclosure may vary according to the types of the electronic device. The electronic device according to various embodiments of the present disclosure may be configured by including at least one of the above-described components. Some components may be omitted from, or additional other components may be further included in the electronic device. When some of the components of the electronic device according to various embodiments of the present disclosure are combined into one entity, the one entity may perform the functions of the components before combination.

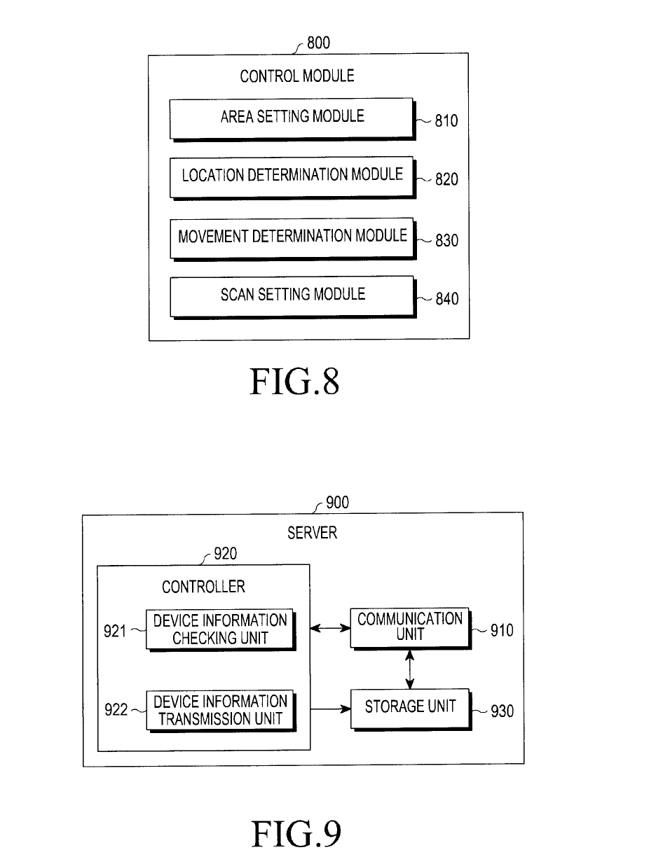

FIG. 8 is a diagram illustrating an example of a configuration of a control module, according to various embodiments of the present disclosure. A control module 800 of the electronic device may operate by being incorporated into an electronic device (e.g., the electronic device 101 or the electronic device 701) as a separate component, or as a part of a processor (e.g., the processor 120 or the AP 710), according to various embodiments of the present disclosure.

Referring to FIG. 8, the control module 800 may include an area setting module 810, a location determination module 820, a movement determination module 830 or a scan setting module 840.

The area setting module 810 may set a service area based on the location information or area information of an electronic device. According to various embodiments of the present disclosure, the area setting module 810 may be set to receive information related to a short-range communication device from a server.

The location determination module 820 may determine whether the electronic device is out of the service area.

The movement determination module 830 may determine movement of the electronic device. According to various embodiments of the present disclosure, the movement determination module 830 may determine the movement, using a pedometer, an accelerometer, a gravimeter, a speedometer or any module or sensor capable of measuring a variety of movement.

The scan setting module 840 may set whether to perform a scanning operation, or set a scan cycle. According to various embodiments of the present disclosure, the scan setting module 840 may determine the information related to a short-range communication device in the service area. The information may be obtained from the server or elsewhere.

The scan setting module 840 may determine to perform a scanning operation by checking the device-related information. For example, the scan setting module 840 may perform the scanning operation, if at least one of the information related to a short-range communication device, which is checked in an initial short-range communication operation, corresponds to the device-related information.

The scan setting module 840 may set a scan cycle depending on the movement of the electronic device. For example, if the movement of the electronic device is detected, the scan setting module 840 may set the scan cycle in the time interval where the movement is detected, to be shorter than a preset value. On the contrary, if it is determined that the electronic device is stopped, the scan setting module 840 may set the scan cycle in the time interval where it is determined that the electronic device is stopped, to be longer than a preset value, or may set the scan cycle so that the scanning operation is not performed at all (e.g., set the scan cycle to a value that is so large that it guarantees that no scans will be performed in the near and/or distant future).

For example, the electronic device according to various embodiments of the present disclosure may include a communication unit for transmitting location-related information of the electronic device to a server, and receiving, from the server, information related to at least one short-range communication device, which is set in response to the location-related information, and a processor for determining whether to perform scanning, based on the received information related to at least one short-range communication device.

The processor according to various embodiments of the present disclosure may determine an area that is set in response to the location-related information, and control the communication unit to perform scanning if it is determined that at least one short-range communication device in the received information related to at least one short-range communication device is present in the set area. The location-related information may include information about an area where the electronic device desires to receive a service. The short-range communication device may be a beacon transmission device.

The processor according to various embodiments of the present disclosure may detect movement of the electronic device, and set a scan cycle in a time interval where the movement is detected.

The processor according to various embodiments of the present disclosure may detect the movement of the electronic device using a signal received from at least one of a pedometer, an accelerometer, a gravimeter and a speedometer.

The processor according to various embodiments of the present disclosure may determine whether the electronic device is out of the set area, and control the communication unit to transmit changed location information of the electronic device to the server, if the electronic device is out of the set area.

FIG. 9 is a diagram illustrating an example of a server, according to various embodiments of the present disclosure. Referring to FIG. 9, a server 900 may include a communication unit 910, a controller 920 and a storage unit 930.

The communication unit 910 may receive location information or area information from at least one electronic device. The communication unit 910 may transmit information about a service area that is set in response to the received location information or area information, to the at least one electronic device.

The communication unit 910 may transmit the information stored in the storage unit 930, under control of the controller 920. For example, the stored information may include information about a service area corresponding to the previously searched location information or area information, and information related to a short-range communication device in the service area.

The communication unit 910 may receive a service request for a specific device. The service request may be made to request a service (e.g., a data transmission service) that at least one electronic device desires to receive in the set service area.

The controller 920 may include a device information checking unit 921 and a device information transmission unit 922, and control other overall operations of the server 900.

The device information checking unit 921 may control the storage unit 930 to check information related to a short-range communication device corresponding to the received location information or area information. The device information checking unit 921 may control the storage unit 930 to check information about a service that can be provided in relation to the device (e.g., a beacon transmission device).

If device information corresponding to the received location information or area information is checked in the storage unit 930, the device information transmission unit 922 may control the communication unit 910 to transmit the checked device information.

If a service related to a specific electronic device is determined, the device information transmission unit 922 may control the communication unit 910 to transmit information about the service to the electronic device.

The storage unit 930 may store location information, area information, or information related to a short-range communication device corresponding to the location information or area information.

The storage unit 930 may store information related to a short-range communication device (e.g., a beacon transmission device). For example, the information related to a short-range communication device may include information about a service that can be provided as the short-range communication device is scanned.

For example, the server according to various embodiments of the present disclosure may include a communication unit for receiving location-related information from at least one electronic device, and a controller for searching for information related to a short-range communication device, which is set in response to the location-related information, and controlling the communication unit to transmit the identified information related to a short-range communication device to the at least one electronic device.

The controller according to various embodiments of the present disclosure may determine that the at least one electronic device is out of an area that is set in response to the location-related information, if the server re-receives location-related information from the at least one electronic device.

The controller according to various embodiments of the present disclosure may control the communication unit to provide a service corresponding to the location-related information to at least one electronic device, if information about the at least one electronic device is found in advance in response to the location-related information.

The term ‘module’ as used herein may refer to the unit that includes at least one of, for example, hardware, software or firmware, or a combination of at least two of them. The ‘module’ may be interchangeably used with the terms, for example, a unit, a logic, a logical block, a component, a circuit, and/or the like. The ‘module’ may be the minimum unit of an integrally configured component, or a part thereof. The ‘module’ may be the minimum unit for performing one or more functions, or a part thereof. The ‘module’ may be implemented mechanically or electronically. For example, the ‘module’ according to various embodiments of the present disclosure may include at least one of an application-specific integrated circuit (ASIC) chip, field-programmable gate arrays (FPGAs) or a programmable-logic device, for performing any operations which are known or will be developed in the future.

At least a part of the device (e.g., modules or functions thereof) or method (e.g., operations) according to various embodiments of the present disclosure may be implemented with instructions stored in computer-readable storage media in the form of, for example, a programming module. If the instruction is executed by one or more processors (e.g., the processor 120), the one or more processors may perform a function corresponding to the instruction. The computer-readable storage media may be, for example, the memory 130. At least a part of the programming module may be implemented (e.g., executed) by, for example, the processor 120. At least a part of the programming module may include, for example, a module, a program, a routine, a set of instructions or a process for performing at least one function.

The computer-readable storage media may include magnetic media (e.g., a hard disk, a floppy, and a magnetic tape), optical media (e.g., Compact Disc Read-Only Memory (CD-ROM), Digital Versatile Disc (DVD)), magneto-optical media (e.g., floptical disk), and a hardware device (e.g., Read-Only Memory (ROM), Random Access Memory (RAM), and a flash memory), which is specially configured to store and execute a program instruction (e.g., a programming module). In addition, the program instruction may include not only the machine code produced by a compiler, but also the high-level language code that can be executed by a computer using an interpreter and/or the like. The above-described hardware device may be configured to operate as one or more software modules to perform the operations according to various embodiments of the present disclosure, and vice versa.

The module or programming module according to various embodiments of the present disclosure may include at least one of the above-described components, some of which may be omitted, or may further include other additional components. The operations performed by the module, the programming module or other components according to various embodiments of the present disclosure may be performed in a sequential, parallel, iterative or heuristic way. In addition, some operations may be executed in a different order, or may be omitted, or other operations may be added.

According to various embodiments, in storage media storing instructions, the instructions are set to allow at least one processor to perform at least one operation when the instructions are executed by the at least one processor. The at least one operation may include an operation of transmitting location-related information of the electronic device to a server, an operation of receiving, from the server, information related to at least one short-range communication device, which is set in response to the location-related information, and an operation of determining whether to perform scanning, based on the received information related to at least one short-range communication device.

As is apparent from the foregoing description, an electronic device, a server, and a method for performing a scanning operation in the electronic device according to various embodiments of the present disclosure are provided. The electronic device may perform a scanning operation, only if there is at least one electronic device (e.g., a beacon transmission device) in the vicinity of the electronic device. Accordingly, the electronic device may perform the scanning operation only for the necessary electronic devices, thereby contributing to an increase in efficiency of the scanning operation.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

FIGS. 1-9 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. A method in an electronic device, comprising:
transmitting, to a server, location-related information associated with the electronic device;
receiving, from the server, service-related information associated with at least one short-range communication device, wherein the service-related information is received in response to the location-related information; and
determining whether to perform a scan for the at least one short-range communication device based on the service-related information.

2. The method of claim 1, further comprising determining whether the at least one short-range communication device is located in a service area identified by the service-related information; and
performing the scan when determined that the at least one short-range communication device is located in the service area.

3. The method of claim 2, wherein the location-related information includes an indication of a preferred service area.

4. The method of claim 1, wherein the short-range communication device includes a beacon transmission device.

5. The method of claim 1, further comprising detecting a movement of the electronic device, wherein the scan is performed in accordance with a scan cycle corresponding to the movement.

6. The method of claim 5, wherein the movement of the electronic device is detected using a signal received from at least one of a pedometer, an accelerometer, a gravimeter and a speedometer.

7. The method of claim 2, further comprising transmitting to the server an update to the location-related information when determined that the electronic device is located outside of the service area.

8. A method in a server, comprising:
receiving location-related information associated with an electronic device;
identifying service-related information associated with a short-range communication device corresponding to the received location-related information; and
transmitting the service-related information to the electronic device.

9. The method of claim 8, further comprising:
identifying a service area based on the identified service-related information; and
determining that the electronic device is located outside of the service area according to receive an update to the location-related information.

10. The method of claim 8, further comprising providing the electronic device with a service corresponding to the location-related information.

11. An electronic device comprising a communication unit and one or more processors configured to:
transmit, to a server, location-related information associated with the electronic device;
receive, from the server, service-related information associated with at least one short-range communication device; and
perform a scan for the short-range communication device based on the service-related information.

12. The electronic device of claim 11, wherein:
the one or more processors are further configured to detect whether the short-range communication device is located in a service area identified by the service-related information, and
the scan is performed in response to detecting that the short-range communication device is located in the service area.

13. The electronic device of claim 12, wherein the location-related information includes an indication of a preferred service area.

14. The electronic device of claim 11, wherein the short-range communication device includes a beacon transmission device.

15. The electronic device of claim 11, wherein:
the one or more processors are further configured to detect a movement of the electronic device, and
the scan is performed in accordance with a scan cycle corresponding to the movement.

16. The electronic device of claim 15, wherein the movement of the electronic device is detected by using a signal received from at least one of a pedometer, an accelerometer, a gravimeter and a speedometer.

17. The electronic device of claim 12, wherein the one or more processors are further configured to transmit to the server an update to the location-related information in response to detecting that the electronic device is located outside of the service area.

18. A server comprising a communication unit and one or more processors configured to:
receive location-related information from an electronic device; and
identify service-related information associated with a short-range communication device in response to receiving the location-related information, and control the communication unit to transmit the service-related information to the electronic device.

19. The server of claim 18, wherein the one or more processors are further configured to detect whether the electronic device is located outside of a service area identified in the service-related information in response to receiving an update to the location-related information from the electronic device.

20. The server of claim 18, wherein the one or more processors are further configured to control the communication unit to provide the electronic device with a service corresponding to the location-related information.
